(19) United States
(12) Patent Application Publication
(10) Pub. No.: US 2009/0157867 A1
(43) Pub. Date: Jun. 18, 2009

(54) SYSTEM AND METHOD FOR REAL-TIME GRAPHIC MONITORING OF DIFFERING GRAPHICS RESOLUTIONS USING A SINGLE GRAPHICS BUFFER

(75) Inventors: Markesha L. Farmer, Durham, NC (US); Makoto Ono, Chapel Hill, NC (US); Edward S. Suffern, Chapel Hill, NC (US); Robert R. Wolford, Strongsville, OH (US)

Correspondence Address: HOFFMAN WARNICK LLC, 75 STATE STREET, 14TH FLOOR, ALBANY, NY, 12207, US

(73) Assignee: INTERNATIONAL BUSINESS MACHINES CORPORATION, Armonk, NY (US)

(21) Appl. No.: 11/958,652

(22) Filed: Dec. 18, 2007

(51) Int. Cl. G06F 15/173

(52) U.S. Cl. 709/224

(57) ABSTRACT

A system and method automatically scale the resolution of video output of a selected workstation blade so that an administrator can view the video output by the selected workstation blade in the same format as it is displayed at the user terminal associated with the selected workstation blade. The video is automatically scaled to the administrator's VGA resolution while maintaining the same end-user DVI resolution and displaying the video so that the administrator may see the video output regardless of display format at the end user. This system and method allows the administrator to see the entire display.

### BACKGROUND OF THE INVENTION

1. Field of the Invention

The present invention generally relates to a system and method for real-time graphic monitoring of differing graphics resolutions. Specifically, the present invention provides a system and method for real-time graphic monitoring of differing graphics resolutions using a single graphics buffer.

2. Related Art

A “workstation blade” is a rack-mountable computer accessible over a network by a user from a remote user terminal networked to the workstation blade. A workstation blade is typically configured for use by a single user, replacing a local desktop computer workstation with a centrally located, rack-mountable computer. An example is shown in FIG. 4 as Blades 424 in Blade Center 422. Computing resources such as the CPU, motherboard, hard drive, and video cards, reside on the workstation blade. An examples of this are shown in FIG. 1. The remote user terminal provides a familiar computing environment, including traditional peripherals, such as one or more user displays, a keyboard, and a mouse, even though these peripherals communicate over the Ethernet with the computing resources that are remotely located on the workstation blade. Examples of this are shown in FIG. 1. This consolidates computing resources for multiple users in a centralized location, allowing users to remotely interface with the centralized computing resources, while allowing a system administrator to more easily manage the computing resources. A system administrator terminal may be used to monitor applications of selected workstation blades over the network, such as to troubleshoot the workstation blade, install software, or perform other management tasks. The BLADECENTER product family from IBM includes some of the more compact chassis arrangements available on the market, and may be configured for use either with multi-user servers or with single-user workstation blades (IBM and BLADECENTER are registered trademarks of International Business Machines Corporation, Armonk, N.Y.). However, other rack-mountable workstation blade systems and their equivalents are available in the industry from a variety of manufacturers.

Workstation blades may be viewed in the context of client-server architecture, even though a server is often configured for use by multiple users and a workstation blade is typically configured for use by a single user. Client-server architecture is a computer network architecture wherein clients rely to some degree on the servers to which they are networked for processing. Examples of this are shown in FIG. 2. Each instance of the client software in a client-server network can send data requests to one or more connected servers. In turn, the servers can accept these requests, process them, and return the requested information to the client. As the concept of client-server architecture is applied to workstation blades, each instance of a workstation blade and associated user terminal form a client-server pair, wherein the workstation blade is on the server side and the user terminal is on the client side. The degree to which processing activities are performed on the server side of a client-server network varies among different systems and manufacturers. The term “thin client” (or “lean client”) is sometimes used to describe a client that has little processing capabilities and relies heavily on its associated server for processing. A thin client may be as simple as a “dumb-terminal” that has no processing capabilities other than conveying input and output between the user and the server, relying extensively or entirely on the computing capabilities of the server to which it is networked. Other types of clients have more processing power, and can run complete operating systems, but may still lack other components usually available on standalone computers, such as media drives.

When monitoring the graphical output (i.e., video output) of a workstation blade, it is helpful for the administrator terminal to display the same video image that is being displayed on the remote user display by the workstation blade. Monitoring a selected workstation blade from an administrator workstation can be problematic, however, due to potential differences in display capabilities and formats between the administrator's display and the numerous individual user displays being used at the client terminals. Most notably, it can be difficult or impossible for an administrator to view the full graphical output of a user who has a high resolution display. Additionally, each user's workstation may have different display drivers and display settings, which further complicates the problem of monitoring the user from the administrator workstation. A still further complication is that video signals from the various workstation blades are typically received and processed by a rack-mounted management module before being sent to the administrator terminal, and the management module has limited capacity for handling video signals. For example, an administrator using a BladeCenter management module in many systems is limited to receiving a maximum 1024×768 display resolution, while the various workstation blades have graphics cards and associated hardware capable of much higher digital resolution.

A solution is therefore needed to allow a system administrator to remotely monitor the video output of a selected user workstation. In particular, a monitoring system is needed that would allow the administrator to monitor the workstation of any user regardless of the user display setup. The system administrator should be able to fully monitor the video from the administrator terminal in the same format as it would be displayed at the associated user terminal. The system administrator should also be able to monitor the video output regardless of the type, size, number, resolution, and other display parameters of the user terminal.

### SUMMARY OF THE INVENTION

The present invention includes a system and method to automatically adjust video settings associated with a selected client so that an administrator can view the graphical output (i.e., video output) in the same format as it is displayed at a user terminal associated with the client. These embodiments include methods for automatically and temporarily adjusting (scaling of the resolution) a user's video output to a display format that allows the administrator to see the entire display. The user display settings may be automatically and temporarily switched to settings that can be transmitted over the network to the administrator and are compatible for properly viewing on the administrator's terminal. Thus, the same video output may be simultaneously displayed at both the remotely located user's terminal and the administrator's terminal.

A first embodiment provides a method of monitoring the video output of network nodes. A first node is instructed to send the video output of the first node to a first networked terminal using a single digital video port of a video card associated with the first node. The first node is also instructed to send the video output of the first node to a second networked terminal from a single analog video port of the video card associated with the first node. The video output sent to the first remote terminal is displayed on a single display of the first remote terminal. The video output sent to the second remote terminal is displayed on a single display of the second remote terminal. For example, the first node may be a workstation blade and the first remote terminal may be a user terminal associated with the workstation blade. The second remote terminal may be an administrator terminal. The administrator's display output is automatically scaled to the administrators display output while the administrator is monitoring the user, so that the user and administrator both view the same video formatted output on their respective terminals simultaneously.

A second embodiment provides a computer program product for implementing the method of the first embodiment. The computer program product may be implemented, for example, on a multi-node computer system, such as a network of workstation blades, wherein each workstation blade is a node, to allow an administrator to selectively monitor the workstation blades. The computer program product includes a computer usable medium with computer usable program code for monitoring video output of network nodes. Computer usable program code is provided for instructing a first node to send video output to a first networked terminal using only one digital video port of a video card associated with the first node, for instructing the first node to send the video output to a second networked terminal from a single analog video port of the video card associated with the first node, for causing the video output sent to the first remote terminal to be scaled and displayed on a the display of the first remote terminal, and for causing the video output sent to the second remote terminal to be displayed with the user display resolution on the second remote terminal. The computer program product allows the user and administrator both view the same video output on their respective terminals in a single-display format.

A third embodiment provides a system including a plurality of networked client-server pairs. Each client-server pair includes a user terminal having at least one user display screen. A management entity includes an administrator terminal networked with the client-server pairs. The management entity is configured for selectively accessing one of the client-server pairs for configuring the associated user terminal according to selected display settings, for receiving graphical output from the selected client-server pair, and for displaying the graphical output on the administrator terminal while the graphical output is simultaneously displayed on the user terminal. For example, the computer system automatically and temporarily allows a user's display output to be simultaneously displayed in a single display output for viewing at both the user terminal and administrator terminal, using the appropriate display settings that are compatible for viewing at both the user terminal and administrator terminal.

Other embodiments, aspects, and advantages of the invention will be apparent from the following description and the appended claims.

### BRIEF DESCRIPTION OF THE DRAWINGS

FIG. 1 shows a system, for suitable for storing and/or executing program code, such as the program code of the present invention.

FIG. 2 shows an illustrative communication network for implementing the method of the present invention.

FIG. 3 illustrates a detailed view of the system of the present invention.

FIG. 4 is a perspective view of a computer system configured for supporting multiple workstation blades in accordance with one embodiment of the invention.

FIG. 5 is a detailed schematic diagram of the computer system configured according to one embodiment of the invention to allow for automatic conversion of a selected work station blade to single-screen VGA settings and simultaneous output of the video at the converted settings to both the user terminal associated with the selected workstation blade and the administrator terminal.

### DETAILED DESCRIPTION OF PREFERRED EMBODIMENTS

The present invention provides a way to automatically adjust video settings associated with a selected client so that an administrator can view the video output in the same format as it is displayed at a user terminal associated with the client. In particular, the present invention may be used to automatically adjust video settings associated with a selected workstation blade so that the administrator can view the video output on an administrator terminal in the same format as it is displayed at a client/user terminal associated with the selected workstation blade. Video output refers not only to moving image video, such as the many video file formats, but also to still image formats, text, and any other graphical output displayable on a display such as an LCD monitor, a CRT, or a plasma screen. The display settings of the workstation blade may be stored, after which the display resolution may be automatically scaled to predefined display settings compatible for viewing at both the administrator terminal and client terminal. This process of adjusting the video output to a format viewable essentially identically on both the remote client and administrator displays may alternatively be referred to herein as “normalizing” the display settings of the administrator and the user.

Common limitations of the graphics card and management module do not accommodate the administrator terminal receiving a high resolution output to a single screen. Thus, one embodiment provides a way to automatically adjust video settings of a selected workstation blade and its associated user terminal so that the complete video output can be accurately displayed simultaneously at an administrator terminal. The video settings of the selected workstation blade may be automatically adjusted to standard VGA settings, which are the “lowest common denominator” display settings capable of being displayed on just about any user display and administrator display, regardless of the driver associated with the user's graphics card. Thus, it does not matter whether the administrator has a high-resolution or low-resolution display.

The invention provides a desirable alternative to manually adjusting display settings at the user terminal and/or at the administrator terminal, which saves time and effort, and prevents inadvertently misconfiguring these settings. The invention may also be used to prevent scenarios wherein, for example, part of the video output is “clipped” due to a smaller display being used at the administrator terminal, or wherein part of the video output is not visible to the administrator due to the user having a dual-display output and the administrator having only a single display, or wherein the video output is simply not displayable at all to the administrator. By allowing the administrator to see exactly what the user sees, the administrator is able to more efficiently and reliably maintain and troubleshoot the system.

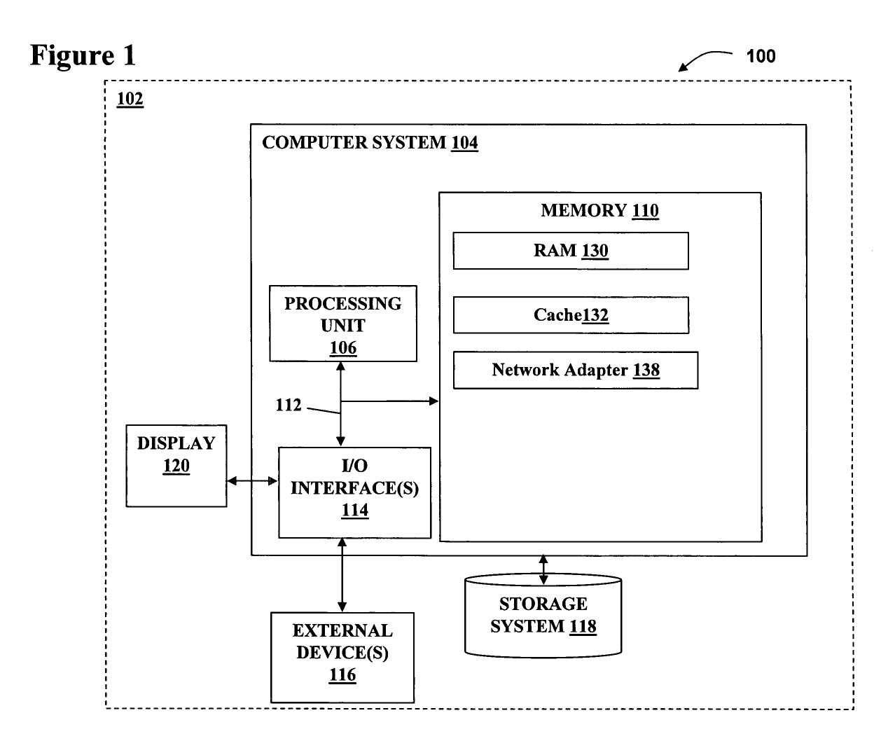

A data processing system, such as that system 100 shown in FIG. 1, suitable for storing and/or executing program code will include at least one processor (processing unit 106) coupled directly or indirectly to memory elements through a system bus. The memory elements can include local memory (RAM 130) employed during actual execution of the program code, bulk storage (storage 118), local storage (Local Hard Drive 132) which provide temporary storage of at least some program code in order to reduce the number of times code must be retrieved from bulk storage during execution. Input/output or I/O devices (external devices 116) (including but not limited to keyboards, displays, pointing devices, etc.) can be coupled to the system either directly or through intervening I/O controllers (I/O Interface 114).

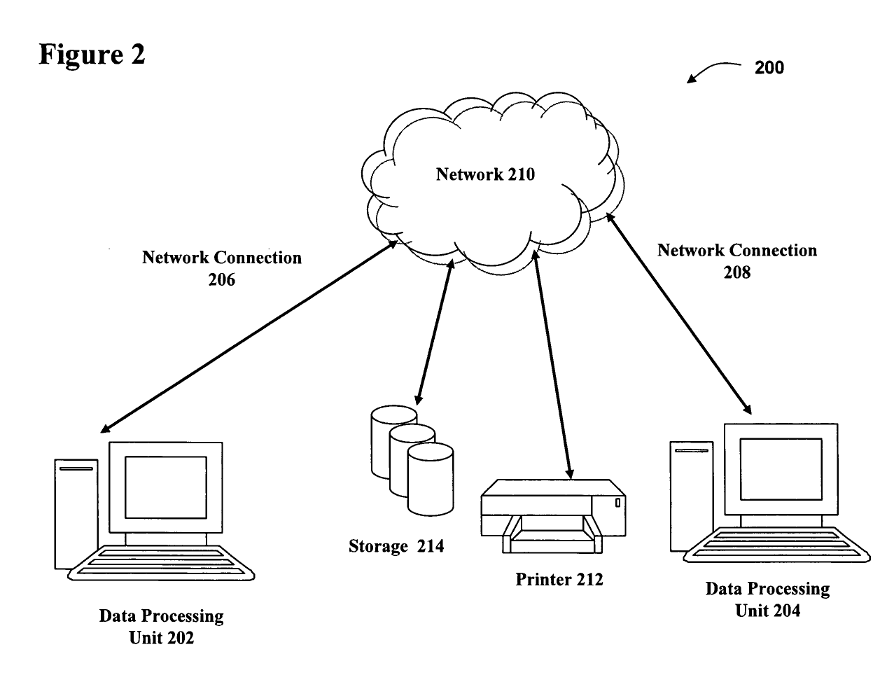

Network adapters (network adapter 138) may also be coupled to the system to enable the data processing system (as shown in FIG. 2, data processing unit 202) to become coupled to other data processing systems (data processing unit 204) or remote printers (printer 212) or storage devices (storage 214) through intervening private or public networks (network 210). (A computer network is composed of multiple computers connected together using a telecommunication system for the purpose of sharing data, resources and communication. For more information, see http://historyoftheinternet.org/). Modems, cable modem and Ethernet cards are just a few of the currently available types of network adapters. (A network card, network adapter or NIC (network interface card) is a piece of computer hardware designed to allow computers to communicate over a computer network. It is both an OSI layer 1 (physical layer) and layer 2 (data link layer) device, as it provides physical access to a networking medium and provides a low-level addressing system through the use of MAC addresses. It allows users to connect to each other either by using cables or wirelessly.) These physical network connections are shown in 206 and 208.

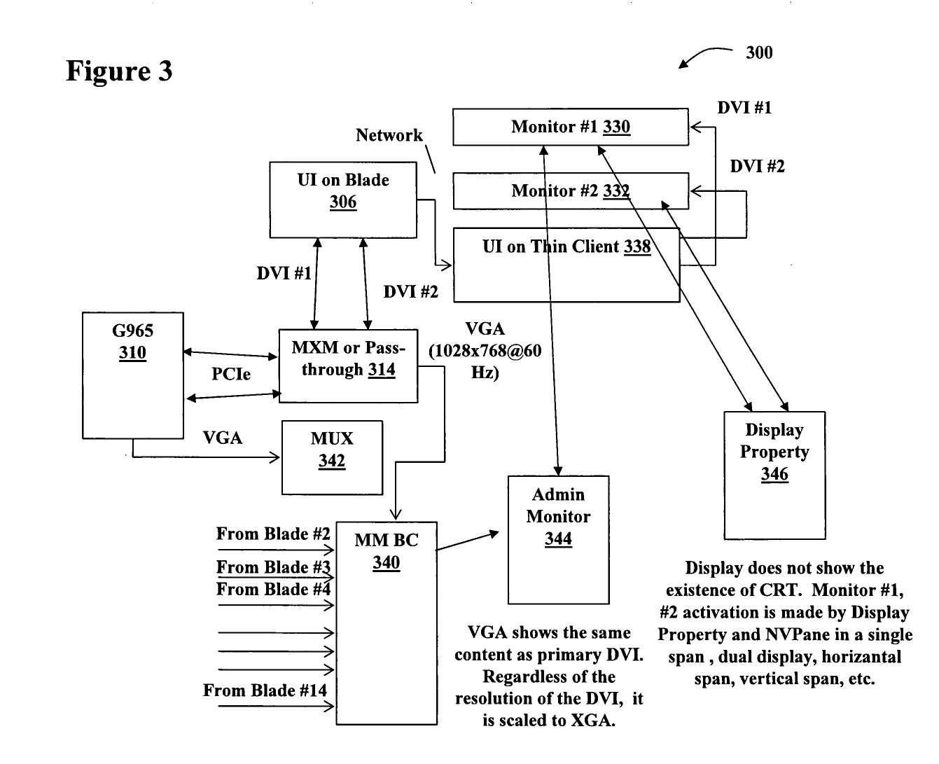

FIG. 3 illustrates the use of a single video buffer for real-time display of differing resolutions to two different monitors. The system and method of the present invention is shown for using both integrated Intel graphics and a separate graphics card to provide VGA video the both the local monitor and the remote IT administrator through the management module compression algorithms. The system and method of the present invention also provides for automatic scaling of graphics resolutions independent of the user monitor resolutions, automatic adaptation if the user changes the remote monitor resolution, automatic adaptation if the user switches ClientBlades within the BladeCenter chassis, and real-time frame-by-frame conversion.

ClientBlade remotes the user desktop experience by placing the processor subsystem in a BladeCenter form factor. ClientBlade then takes high-resolution graphics, compresses the video, packetizes the video into TCP/IP packets and transmits it over the Ethernet local or remote area network. There is a requirement from the IT administrator to monitor the remote user graphics display at the management module console for problem determination at the same time the user is viewing the display. The problem occurs because of the different video graphics options that can be installed in the ClientBlade and the different resolutions supported by the ClientBlade user monitors. The ClientBlade user monitor resolutions are too great to be supported by the local BladeCenter monitor or the management module compression algorithms without a special circuit. What is needed is a consistent method to allow the management module to monitor the video signals when the Intel chipset graphics is used or when the users installs a high resolution graphics card and remotely sends graphics information to the remote user. This solution must be device driver free, independent of the remote user display resolution, and switch automatically to different ClientBlade within BladeCenter. This signal must be supplied to the BladeCenter chassis monitor as well as to the management module. This disclosure provides a single method for supporting remote graphics display simultaneously with the local or remote management module console with a limited or fixed resolution.

In the first case, the VGA output of the Intel graphics chip 310 is sent to a multiplexer 342 and on to the midplane. This output occurs simultaneously with SDVO video being sent to a pass-through card 314, which converts it into DVI signals for a video compression card. Since the Intel chipset graphics is not high resolution, the management module can adapt to this resolution automatically. The display seen by the user on monitor 330, is the same as the screen seen by the IT administrator on the management module console 344. The VGA shows the same content as primary DVI. Regardless of the resolution of the DVI, it is scaled to XGA. Display does not show the existence of CRT. Monitor 330 activation is made by Display Property 346 and NVPane in a single span, dual display, horizantal span, vertical span, etc.

In the second case, a present detect pin in the video graphics cards switches the multiplexer 342 to the installed high-resolution graphics card. In this case, the management module compression algorithms cannot match the resolution density of the remote user display. Neither can the locally attached monitor if it is installed. To resolve this problem, the graphics processing unit, 314 is designed to provide a scaling function to preset the VGA output to a standard resolution acceptable by the management module 340, user independent of the end user resolution, e.g., if the frame buffer of DVI is configured to 1600×1200, the DVI should send 1600×1200 signal to the ClientBlade user, but scaled VGA output of the graphics chip provides 1024×768@60 Hz signal to the multiplexer 342. This content is scaled from 1600×1200 to 1024×768. So even though the high-resolution graphics capability is not present to the management module user, that management module and IT administrator are still able to monitor what the ClientBlade user sees. The IT administrator views the same display information at the Administration Monitor, 344 as does the end user, 346 as the information is transmitted over the network to a remote user using, the User Interface (UI) on the blade, 306 and the User Interface (UI) on the thin client, 338 as it is transmitted to the monitor, 330.

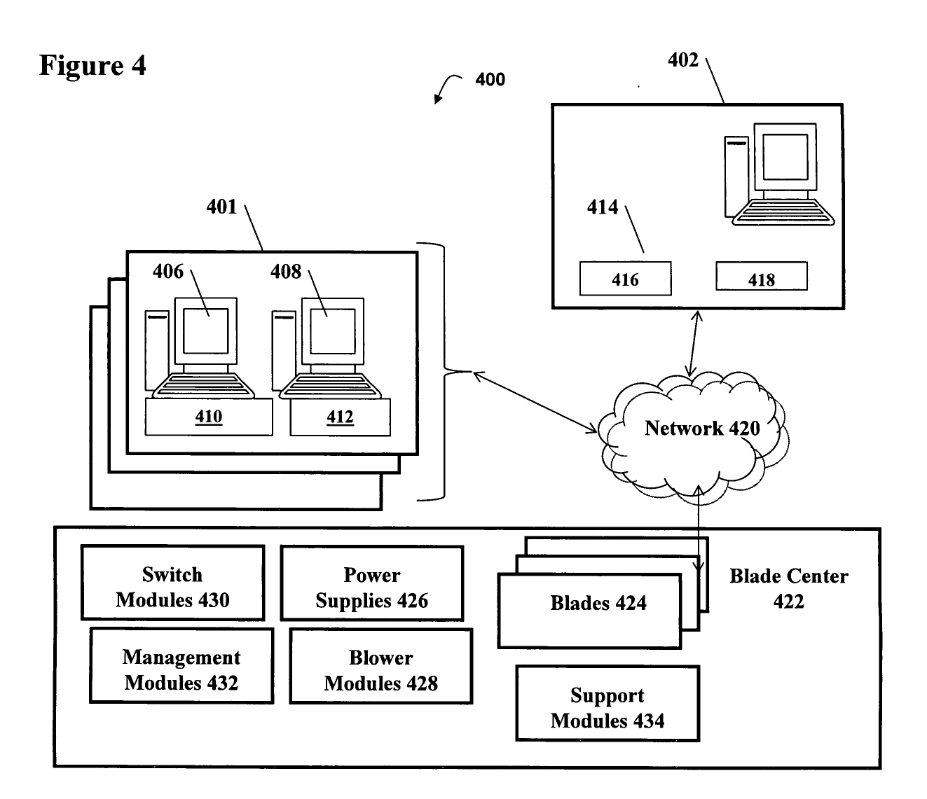

FIG. 4 is a perspective view of a computer system 400 configured for supporting multiple workstation blades 424 in accordance with one embodiment of the invention. The computer system 400 shown includes a rack-mountable, BladeCenter® style chassis 422, which is one example of a wide variety of options available in the industry for supporting workstation blades. However, the invention does not require the use of IBM products, and may be applied to any of a variety of workstation blade systems and similar systems available on the market. Each workstation blade 424 may include one or more microprocessors, hard drives, and memory to service the client-server network. The computer system 400 includes a variety of shared support modules installed in the chassis 422, including one or more power supply modules 426, one or more blower modules 428, and multiple switch modules 430. A rack-mounted management module 430 is an electronic controller that manages the chassis, workstation blades, and other modules. The management module 432 has an Ethernet point-to-point connection with each of the switch modules 430, and with all other major chassis components. The power modules 426 provide power to the system. The blower modules 428 generate airflow through the chassis 422 to cool the computer system. The switch modules 430 provide network connectivity between the workstation blade I/O and the network. An optional acoustic module (not shown) may be included to reduce noise.

Each workstation blade 424 is associated with a user terminal 406, 408, so that the computer system 400 supports a number of users equal to the number of workstation blades installed in the chassis 422. Each workstation blade 424 houses internal computer components such as processors and heatsinks, DIMMs, one or more hard drives, and adapter cards. Each workstation blade 424 may also include a baseboard management controller (BMC), which is a specialized microcontroller embedded in the motherboard whose functionality includes receiving input from different sensors and sending an alert to the administrator if any parameters do not stay within predefined limits. The workstation blades 424 are installed in the front of the chassis 422 and the support modules 434 are installed in the rear of the chassis 422. The workstation blades 424 and support modules 434 meet at an internal chassis interface known as the midplane, which provides all of the interconnections among the workstation blades 424, modules, media tray, and DC power distribution throughout the chassis. Connectors at the midplane couple the workstation blades 424 with the support modules 434 to reduce wiring requirements and facilitate installation and removal of the workstation blades 424. In the context of client-server networking terminology, each workstation blade 424 is on the server side, and each user terminal 406, 408 is on the client side of a client-server pair formed between the user terminal 406, 408 and the associated workstation blade 424.

Each workstation blade 424 is a network node, and each associated user terminal 406, 408 may also be a network node, with each workstation blade 424 and associated user terminal 406, 408 networked over a network 420. The user terminal 406, 408 enables an individual user to communicate with the associated workstation blade 424 over the network 420 using a combination of input peripherals such as a keyboard and pointing device, and one or more output peripheral such as displays 406, 408. Terminals are sometimes divided into three classes based on how much processing power they contain. An “intelligent terminal” describes a stand-alone device that contains main memory and a CPU. A “smart terminal” contains some processing power, but not as much as an intelligent terminal. A “dumb terminal” has no processing capabilities, and relies entirely on the server-side processor. The user terminal 406, 408 provides a familiar computing environment to a user located at the user terminal 406, 408, even though the processor complex and related computing hardware are on the workstation blade 424, which is centrally located at the chassis 422. Additional user terminals also interface with their associated workstation blade 424 over the network 420.

An administrator terminal 402 is also networked with the computer system 400 over the network 420. The administrator terminal 402 is similar in some respects to a user terminal in that it provides a familiar computing environment to a human administrator. Here, the administrator terminal 402 includes administrator input/output peripherals including at least one administrator display, along with a keyboard and pointing device. The administrator terminal 402 is uniquely configured to allow an administrator to selectively access any of the workstation blades and monitor what is being displayed on the associated user terminals, such as to perform maintenance, troubleshooting, or software installation. For example, when accessing the workstation blade 424 from the administrator terminal 420, the computer system 400 adjusts the displayed output so that what is being displayed on the administrator terminal 402 is the same as what is being displayed on the user terminal 406, 408. The system 400 also automatically adjusts the display settings of the user terminal 406, 408 to a predefined group of settings, such as resolution, refresh rate, and display area that is capable of being displayed on both the single user display 406 and the administrator display 418.

In one embodiment, the predefined group of display settings are a group of settings that can be output by any VGA (Video Graphics Array) output. VGA is an analog computer display standard to which the majority of manufacturers previously conformed. VGA can be output independent of any graphics driver. DVI (Digital Video Interface), by contrast, is a newer video interface standard designed to maximize the visual quality of digital display devices such as flat panel computer displays. VGA settings can be displayed on newer digital display devices, but DVI settings typically cannot be viewed on older analog display devices. VGA settings, therefore, provide the “lowest common denominator” that all client graphics hardware supports before a device-specific driver is loaded onto the computer. Most graphics cards contain one VGA output port and two DVI output ports, and can only output video signals over any two of the three ports (VGA, DVI-1, and DVI-2) at any given moment. VGA settings are convenient and reliable to use in the context of this invention because the user displays 406, 408 and the administrator display(s) 418 are likely to have the ability to display graphical output according to the VGA specification, regardless of their age, type, or video drivers. Also, a management module 432 (discussed below in connection with FIG. 4) conventionally accepts up to a 1024×768 VGA display signal. Thus, converting the video output of a selected workstation blade to VGA-capable settings and providing that video output to both the user terminal and the administrator terminal allows an administrator to view the video on the administrator display 418 in a display format that duplicates the display format as viewed on one of the user displays 406, 408. The invention provides a system and method to automatically perform this conversion to a single-display output using VGA-standard settings. The video output to the user terminal may be in a digital format, whereas the video output to the administrator terminal may be in analog format.

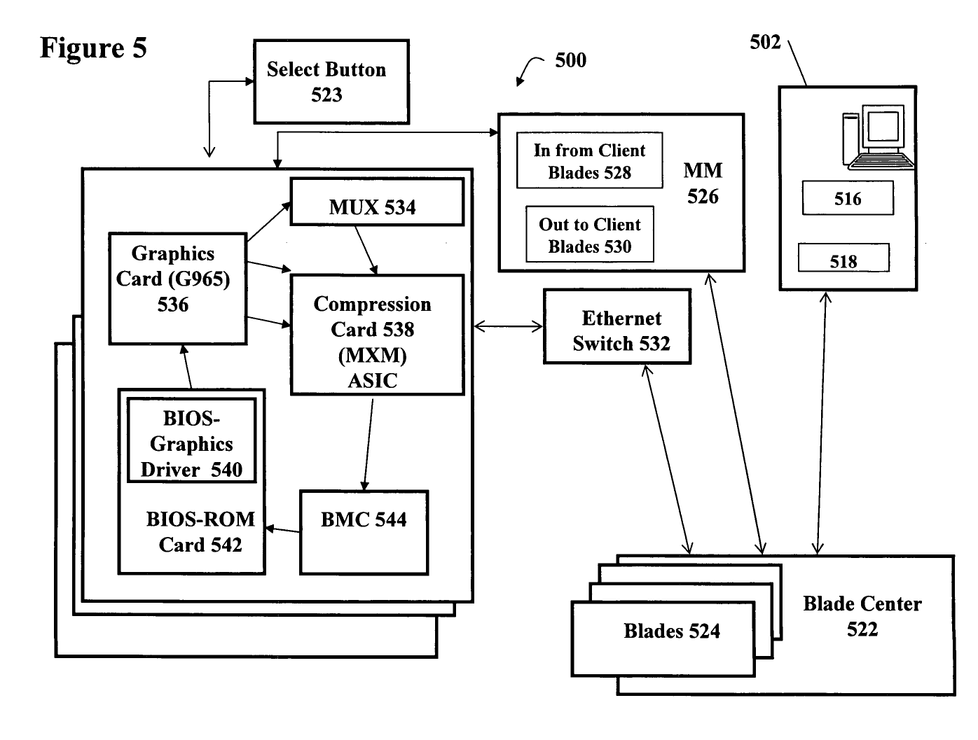

FIG. 5 is a detailed schematic diagram of the computer system 500 configured according to one embodiment of the invention to allow for automatic conversion of a selected workstation blade 524 to single-screen VGA settings and simultaneous output of the video at the converted settings to the user terminal 516, associated with the selected workstation blade 524 and the administrator terminal. In the context of client-server networking terminology, the user terminal 516 is on the client side of a client-server pair and the workstation blade 524 is on the server side of a client-server pair. The workstation blade 524 in this embodiment includes a output 536, which may include a “G695” chip or separate graphics card, a User Interface compression card 538, a baseboard management controller (BMC) 544, and a BIOS-ROM 542 containing a BIOS graphics driver 540. The user terminal 410, 412 includes the user displays 406, 408. The workstation blade 524 interfaces with the midplane, and signals are routed between the workstation blade 524 and the user terminal 410, 412 over an Ethernet switch 532. A management module 432 installed in the chassis supports the workstation blades, providing a single point of control for the workstation blades and other modules.

During normal use, when not being monitored by the administrator terminal 402, the video output may be displayed on the user terminal 406, 408 according to the preferences and settings of the user terminal 410, 412. The graphics card 536 reads the EDID (extended display identification data) provided by the user display(s) 410, 412 to describe their capabilities to the graphics card 536. Video is sent to the user displays 410, 412 based on their respective EDID. The workstation blade 524 takes any high-resolution graphics, compresses the video, packetizes the video into TCP/IP packets and transmits it over the Ethernet local or remote area network using the compression card 538 to the displays 410, 412. The remote client display resolution and other display settings may therefore be varied as desired by the user, as usual.

When the system administrator (i.e., “IT administrator”) desires to monitor the workstation blade 524 using the administrator terminal 402, the administrator needs to view all of the video output in a format that can be displayed on the administrator terminal 402 in a remote network environment or locally in terminal 502 if the display is connected directly to the BladeCenter 522. According to the invention, a process is therefore used to automatically adjust the display settings of the workstation blade 524 so that the graphical output is viewable at both the administrator terminal 402 and at the user terminal 410, 412. In this embodiment, this is done by switching the video output to a single display format at both the user terminal 410, 412 and administrator terminal 402 and normalizing the display settings to the lowest common denominator VGA settings.

This process may be described as follows. When an administrator desires to monitor the video output of the workstation blade 524, the administrator first selects the client-server pair consisting of the workstation blade 524 and associated user terminal 410, 412 by pressing the selection button 523. The selection button 523 may physically reside on the workstation blade 524 being selected. While the user terminals may all be remotely located with respect to the computer system 500, the administrator terminal 502 may be located in the same room or same building as the computer system 500, thus placing the selection button 523 within convenient access of the administrator. Alternatively, particularly if the administrator is also remotely located with respect to the computer system 500, a virtual selection button 523 could be provided allowing the administrator to select the workstation blade 524 directly from the administrator terminal 402.

In response to the pressing of the button 523, the management module 432 instructs the BMC 544 to limit the video output to the workstation blade 524 to a single display and a defined resolution. The BMC 544 informs the compression card 538 and the BIOS 542 of the change. Generally, management modules are limited to receiving analog, VGA video at a maximum of 1024×768 resolution. Simultaneously, the BIOS 542 commands the graphics card 536 to switch to the VGA output to the management module to both the user terminal and the administrator terminal at a resolution equal to the resolution of the administrator terminal while maintaining the same resolution at the user terminal. This results in a forced display output of the same content at the user terminal 410, and the remote administrator terminal 402, even though one output may be digital and the other output may be analog. The video displayed on the administrator terminal 402 may still be in a digital format, but is optionally limited to the VGA-capable resolution settings (e.g., 1024×768). The user terminal 410 maintains the same resolution on the display 406. This process is accomplished in the graphics card 536 which outputs the video from the VGA output to the management module 432 at the resolution accepted by the administrator's terminal 402. The management module 432 processes the video, including converting the analog VGA signal to a digital signal and compressing the video, and then passes the processed video through the Ethernet switch 532 to the decompression module at the administrator terminal 402. The decompression module decompresses the signal and displays it at the selected VGA settings on the administrator display 402. Locally, the VGA analog signal is routed directly to the local administrator's display, 502.

Desirably, the process outlined above takes place automatically in response to selecting a client-server pair. Thus, the administrator need not physically go to the associated user terminal, which may be located remotely, to manually adjust the display settings. Nor does the administrator need to instruct the user to manually convert the settings. Automatically converting the video output to the VGA-compliant settings allows the administrator to view the video output from the selected workstation blade, regardless of the type of administrator display, and regardless of the brand, type, or driver of the graphics card. Automatically converting the video output to the user's screen format allows the administrator to view all of the video output from the workstation blade on the single display, whether or not the administrator terminal has the same resolution capabilities.

It should be recognized that the invention may take the form of an embodiment containing hardware and/or software elements. Non-limiting examples of software include firmware, resident software, and microcode. More generally, the invention can take the form of a computer program product accessible from a computer-readable medium providing program code for use by or in connection with a computer or any instruction execution system. For the purposes of this description, a computer-usable or computer readable medium can be any apparatus that can contain, store, communicate, propagate or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), and DVD.

A data processing system suitable for storing and/or executing program code typically includes at least one processor coupled directly or indirectly to memory elements. For example, the processors used to execute the program code may reside on or include the management module 432, BMC 544, graphics card 536, compression card 538, or BIOS-ROM 540. The memory elements can include local memory employed during actual execution of the program code, bulk storage, and cache memories that provide temporary storage of at least some program code in order to reduce the number of times code must be retrieved from bulk storage during execution. For example, executable program code or elements thereof may reside on or be communicated between any of the management module 432, graphics card 536 (e.g., in the driver thereof), compression card 538, BIOS-ROM (e.g., in the BIOS graphics driver) 542, or other memory storage elements in communication with these components.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of monitoring the video output of network nodes, comprising the steps of:
instructing a first node to send the video output of the first node to a first networked terminal using a single digital video port of a video card associated with the first node;
instructing the first node to send the video output of the first node to a second networked terminal from a single analog video port of the video card associated with the first node; and
displaying the video output sent to the first remote terminal on a single display of the first remote terminal.

2. The method of claim 1, wherein the first node comprises a selected one of a plurality of rack-mounted workstation blades and the first networked terminal comprises a user terminal associated with the selected workstation blade.

3. The method of claim 2, wherein the second networked terminal comprises an administrator terminal configured for selectively monitoring any of the plurality of rack-mounted workstation blades.

4. The method of claim 1, wherein the steps of instructing the first node to send the video output of the first node to the first networked terminal and instructing the first node to send the video output of the first node to a second networked terminal are performed automatically by an electronic controller in response to the selection of the first node from among the network nodes.

5. The method of claim 1, further comprising:
automatically changing the display settings of the video output sent to the first terminal to selected display settings capable of being output by both the analog video port and by the digital video port.

6. The method of claim 5, further comprising:
storing the display settings associated with the graphics card prior to reducing the resolution of the video output sent to the first terminal; and
subsequently restoring the display settings on the graphics card to the stored display settings.

7. The method of claim 5, wherein the selected display settings comprise a display resolution of no more than 1024×768.

8. The method of claim 1, wherein the digital video port comprises a DVI port and the analog video port comprises a VGA port.

9. The method of claim 1, further comprising a client-server network architecture, wherein the first networked node is on the client side of a client-server pair and the first terminal is on the client side of the client-server pair.

10. A computer program product comprising a computer usable medium including computer usable program code for monitoring video output of network nodes, the computer program product including:
computer usable program code for instructing a first node to send video output to a first networked terminal using only one digital video port of a video card associated with the first node; and
computer usable program code for causing the video output sent to the first remote terminal to be displayed on a single display of the first remote terminal.

11. The computer program product of claim 10, wherein the first node comprises a selected one of a plurality of rack-mounted workstation blades and the first networked terminal comprises a user terminal associated with the selected workstation blade.

12. The computer program product of claim 11, wherein the second networked terminal comprises an administrator terminal configured for selectively managing any of the plurality of rack-mounted workstation blades.

13. The computer program product of claim 11, further comprising:
computer usable program code for changing the display settings of the video output sent to the first terminal to selected display settings capable of being output by the analog terminal; and
computer usable program code for sending the video output to the second networked terminal from the single analog video port according to the selected display settings.

14. The computer program product of claim 13, further comprising computer usable program code for sending the video output to the first networked terminal according to the selected display settings.

15. The computer program product of claim 13, further comprising computer usable program code for scaling the analog output to the resolution of the administrator's terminal while maintaining the end user resolution, for connecting locally the administrator terminal; and for connecting remotely the administrator terminal.

16. A system, comprising:
a plurality of networked client-server pairs, each client-server pair including a user terminal having at least one user display screen; and
a management entity including an administrator terminal networked with the client-server pairs, the management entity configured for selectively accessing one of the client-server pairs for configuring the associated user terminal according to selected display settings, for receiving graphical output from the selected client-server pair, and for displaying the graphical output on the administrator terminal while the graphical output is simultaneously displayed on the user terminal.

17. The system of claim 16, wherein the selected client-server pair comprises a server-side workstation blade.

18. The system of claim 17, wherein the selected client-server pair further comprises a graphics card having a digital display port and a VGA port and is configured for transmitting the graphical output to the one user display screen on one of the DVI ports and transmitting the graphical output to the administrator terminal on the VGA port.
